(19) United States
(12) Patent Application Publication
(10) Pub. No.: US 2020/0233433 A1
(43) Pub. Date: Jul. 23, 2020

(54) VIRTUAL WALL DEVICE AND ROBOT AND CONTROL METHOD THEREOF

(71) Applicant: Jason YAN, New Taipei City (TW)

(72) Inventor: Jason YAN, New Taipei City (TW)

(21) Appl. No.: 16/438,980

(22) Filed: Jun. 12, 2019

(30) Foreign Application Priority Data
Jan. 23, 2019 (TW) 108102486

(51) Int. Cl. G05D 1/02

(52) U.S. Cl. CPC G05D 1/0276; G05D 2201/0215; A47L 2201/04; G05D 1/0214

(57) ABSTRACT

The present invention is a virtual wall device and a robot and a control method thereof, comprising the virtual wall device and the robot. The virtual wall device can transmit a virtual wall signal to divide a workspace where the virtual wall device is located into separated areas and open areas. The virtual wall device uses a setting unit provided by itself to set an activity time in the separated area, and the robot determines whether to enter the separated area according to the virtual wall signal, and only after the activity time is reached after entering the separated area, the robot can leave the separated area autonomously without the guidance of the virtual wall device, and enter the open area, thus both the virtual wall device and the robot can save electric power.

### REFERENCE TO RELATED APPLICATIONS

The present application is based on, and claims priority from, Taiwan application number 108102486, filed on 23th Jan. 2019, the disclosure of which is hereby incorporated by reference herein in its entirety.

### BACKGROUND OF THE INVENTION

### Field of the Invention

The present invention relates to a virtual wall device and a robot, and more particularly to a virtual wall device for setting an activity time of the robot in a specific area, and a method for controlling the movement of the robot in different areas.

### Description of the Prior Art

In recent years, the fields in which robots are used have become more and more extensive. Taking cleaning robots as an example, since cleaning robots have been continuously added and improved with various functions, their cleaning ability have been greatly improved. From the suspicion of the cleaning ability of cleaning robots to the present day when people are increasingly able to accept using cleaning robots for cleaning, just like using a washing machine to replace most traditional manual laundry.

Among the many cleaning robot functions, one of which is the virtual wall function that uses a virtual wall device to transmit a specific signal to separate a communicating space into two areas, thereby restricting the cleaning robot to move in one of the areas. For example, the main technical feature disclosed in the U.S. Pat. No. 6,690,134 B1 is that, when a cleaning robot receives a light source emitted by a virtual wall device (i.e. the robot confinement transmitter in this U.S. patent), the cleaning robot performs an avoidance behavior and stays away from the light source.

However, the technical feature disclosed in the aforementioned U.S. Pat. No. 6,690,134 B1 does not cause the cleaning robot to enter another area for cleaning. Therefore, a number of manufacturers have proposed improvement plans for this function, and respectively filed patent applications, such as Chinese invention patents CN102262407B and CN102048499B, etc.

Taking the Chinese patent no. CN102262407B as an example, the paragraph 0039 of the specification says, “Please refer to FIG. 2C, after the sweeping robot 110 cleans the area 220, the sweeping robot 110 changes to transmit the ultrasonic coded signal UW2. After the guiding device 130B receives the ultrasonic coded signal UW2, it is changed to transmit the wireless guiding signal IR2. The sweeping robot 110 can then leave the area 220 according to the wireless guiding signal IR2 and enter the area 230 to start the cleaning work.”, and the paragraph 0044 says, “Additionally, the sweeping robot 110 itself has a timing function. For example, after the sweeping robot 110 has been cleaning for 30 minutes, it is changed to transmit the ultrasonic coded signal UW2 in order to enter another area for cleaning.” Furthermore, the paragraph 0045 further states that, “In other embodiments, when the sweeping robot 110 enters a new area, it can first move along walls to calculate an approximate size of the area and to calculate an estimated amount of time required to clean the area. When the actual cleaning time is equal to the estimated time, the sweeping robot 110 transmits the ultrasonic coded signal UW2 for entering another area for cleaning.” That is to say, in this Chinese patent, the sweeping robot 110 needs to move along the walls every time first after entering a new area to calculate the estimated time. Then, when the cleaning time is equal to the estimated time, the sweeping robot 110 needs to change to transmit the ultrasonic coded signal UW2 to the guiding device 130B (corresponding to the aforementioned virtual wall device), and the wireless guiding signal IR2 is transmitted by the guiding device 130B to guide the sweeping robot 110 to leave the area 220 and enter the area 230.

It can be known from the foregoing that the sweeping robot of the Chinese patent no. CN102262407B needs to move along the walls every time first after entering a new area to calculate the estimated time, such behavior wastes a lot of the battery power of the cleaning robot. Moreover, between the cleaning robot and the guiding device need to send and receive different signals back and forth in order to enter and exit the different areas and complete the cleaning work in the different areas, which greatly consume the battery power of the cleaning robot and the guiding device.

However, the capacities of the batteries of the cleaning robot and the guiding device are limited, and therefore any behavior that wastes electric power should be improved.

### SUMMARY OF THE INVENTION

In view of the problem in the prior art that the conventional cleaning robot and the guiding device waste the battery power, one object of the present invention is that, a robot does not need to perform any action mode to calculate the required cleaning time of each area, but instead a virtual wall device provides a length of activity time required in separated areas. Another object of the present invention is that, the robot does not need to depend on a guiding signal of the virtual wall device in order to leave the currently separated area, but leaves the separated area autonomously after reaching the activity time.

According to the above objects of the present invention, a virtual wall device is provided, comprising a setting unit, a virtual wall control unit, and a virtual wall signal transmitting unit, wherein the setting unit is disposed on a surface of a casing and connected to the virtual wall control unit, and the setting unit is for setting an activity time of a robot entering a separated area, and providing an activity time information to the virtual wall control unit according to the set activity time. The virtual wall signal transmitting unit is connected to the virtual wall control unit, and receives the activity time information through the virtual wall control unit, and sends a virtual wall signal including the activity time information, so that the robot receives the virtual wall signal to cause the robot to determine a length of the activity time in the separated area based on the activity time information of the virtual wall signal, and to use the virtual wall signal to divide a workspace of the robot into the separated area and an open area.

According to the above objects of the present invention, a control method of a virtual wall device is provided. The virtual wall device performs the following steps: a setting unit of the virtual wall device outputting an activity time information of a robot entering a separated area to a virtual wall control unit, the virtual wall control unit transmitting the activity time information to a virtual wall signal transmitting unit of the virtual wall device, and the virtual wall signal transmitting unit sending a virtual wall signal including the activity time information.

According to the above objects of the present invention, a robot is provided, comprising a robot control unit, a virtual wall signal receiving unit, and a driving unit. The driving unit is connected to the robot control unit and drives the robot to move. The virtual wall signal receiving unit is connected to the robot control unit and receives a virtual wall signal outputted by a virtual wall signal transmitting unit of a virtual wall device, and the virtual wall signal comprises an activity time information of a separated area the robot entering and divided by the virtual wall signal. Under the state of allowing to enter the separated area, the robot control unit uses a restriction command to cause the driving unit to drive the robot to move in the separated area during an activity time and prohibits to drive the robot to leave the separated area, and when the activity time is reached in the separated area, the robot control unit uses a leaving command to cause the driving unit to drive the robot to leave the separated area.

According to the above objects of the present invention, a control method of a robot is provided. The robot at least comprises a robot control unit, a virtual wall signal receiving unit, and a driving unit, and performs the following steps: the virtual wall signal receiving unit receiving a virtual wall signal outputted by a virtual wall signal transmitting unit of a virtual wall device, wherein the virtual wall signal comprises an activity time information of a separated area the robot entering and divided by the virtual wall signal, the virtual wall signal receiving unit transmitting the received virtual wall signal to the robot control unit, the robot control unit obtaining the activity time information from the virtual wall signal, when the robot control unit using a restriction command to cause the driving unit to drive the robot to enter the separated area divided by the virtual wall signal, the robot control unit starting timing, so that the robot control unit continuing to use the restriction command to cause the driving unit to prohibit to drive the robot to cross the virtual wall signal during an activity time until an interval of timing of the robot control unit in the separated area reaching the activity time, the robot control unit using a leaving command to cause the driving unit to drive the robot to leave the separated area.

According to the above objects of the present invention, a control method for restricting movement of a robot by a virtual wall device is provided, for applying between the virtual wall device and the robot, and performing the following steps: the virtual wall device selectively setting an activity time of the robot entering a separated area, the robot sending a detection signal during travelling, the virtual wall device sending a virtual wall signal by receiving the detection signal, the virtual wall signal comprising an activity time information generated according to the activity time, the robot receiving the virtual wall signal, and after confirming being able to enter the separated area divided by the virtual wall signal, the robot obtaining the activity time information from the virtual wall signal, the robot starting timing to generate an interval of timing, before the interval of timing reaching the activity time, prohibiting the robot from crossing the virtual wall signal until the interval of timing of the robot reaching the activity time, allowing the robot to cross the virtual wall signal to leave the separated area.

The present invention has one or more of the following advantages:

1. A user can set the activity time of the robot in the separated area on the virtual wall device according to the size of a room, so as to solve the problem that the traditional robots need to first move along the walls in the separated area to calculate the required cleaning time, resulting in wasting the robot electric power.

2. The robot leaves the separated area autonomously after the interval of timing of the robot has reached the activity time without the guidance of the virtual wall device, thereby reducing the electric power consumption of the virtual wall device.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a schematic view of the state of use of the present invention;

FIG. 2 is a block diagram of a virtual wall device of the present invention;

FIG. 3 is a flow chart of a control method of the virtual wall device of the present invention;

FIG. 4 is a block diagram of a robot of the present invention;

FIG. 5 is a flow chart of a control method for restricting movement of the robot of the present invention; and

FIG. 6 is a flow chart of a control method for restricting movement of the robot by the virtual wall device of the present invention.

### DETAILED DESCRIPTION OF THE PREFERRED EMBODIMENT

For the benefit of the examiner to understand the features, contents, advantages and achieved efficacies of the present invention, the present invention will be described in detail below with reference to the accompanying drawings and the embodiments. The objectives of using the drawings are intended to be illustrative only and to assist in explaining the specification, and are not intended to limit the scope of the claims of the present invention in actual implementation.

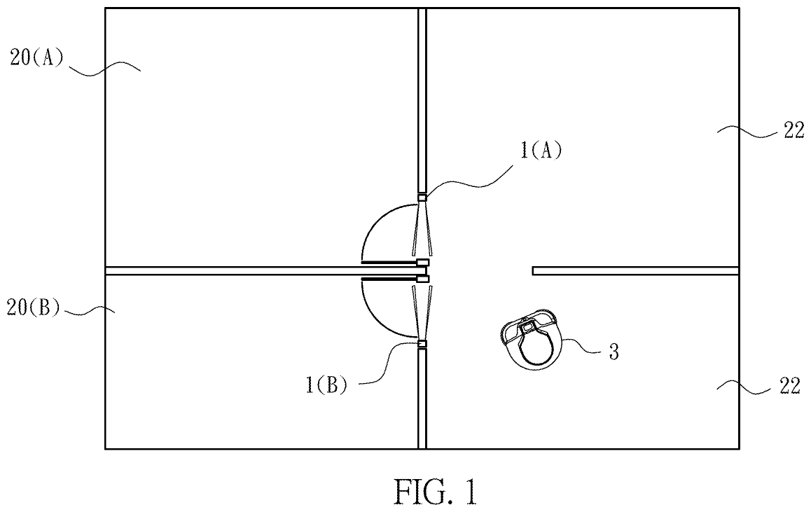

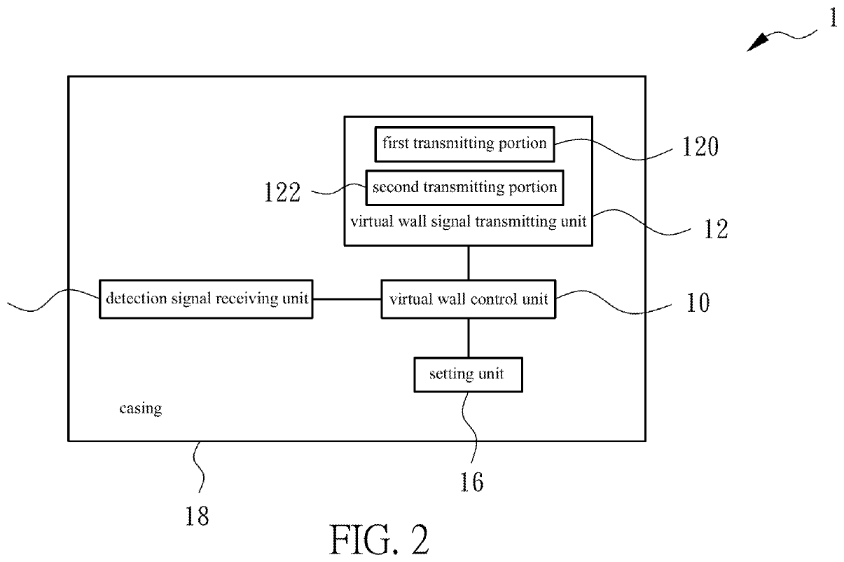

Referring to FIG. 1 and FIG. 2, the present invention is a virtual wall device. A virtual wall device 1 at least comprises a virtual wall control unit 10, a virtual wall signal transmitting unit 12, a detection signal receiving unit 14, and a setting unit 16. The virtual wall signal transmitting unit 12 is connected to the virtual wall control unit 10, and receives an activity time information via the virtual wall control unit 10, and sends a virtual wall signal including the activity time information. The virtual wall signal divides a workspace 2 into separated areas 20 and open areas 22 to cause a robot 3 to obtain an activity time based on the activity time information of the virtual wall signal, and thereby determining how much time the robot 3 is active in the separated area 20 according to the activity time. The detection signal receiving unit 14 receives a detection signal sent by the robot 3, and transmits the received detection signal to the virtual wall control unit 10. The virtual wall control unit 10 activates the virtual wall signal transmitting unit 12 during the period of receiving the detection signal to cause the virtual wall signal transmitting unit 12 to send the virtual wall signal. The setting unit 16 sets a length of the activity time of the robot 3 entering the separated area 20. In order to facilitate a user to operate the setting unit 16, a part of the setting unit 16 is disposed on a surface of a casing 18 of the virtual wall device 1, and another part is disposed in the casing 18 and connected to the virtual wall control unit 10. The user operates the setting unit 16 to set the activity time, so that the virtual wall control unit 10 generates the activity time information according to the activity time.

Since an approximate length of time required for the robot 3 to move in the separated area 20 to complete the work can be known by estimating a moving speed of the robot 3 and an area of the separated area 20, it is only required to calculate in advance a length of time respectively required for the robot 3 to complete the work in the different separated area 20, and notes are provided on the user manual, the virtual wall device 1 or the robot 3 for the user's reference. For example, notes are provided on the user manual that every square meter takes about 3 minutes of work time of the robot 3, so the user can set the activity time respectively according to the size of each room in the house. Of course, the setting condition in the room also affects the length of the activity time, so the user can also use the setting unit 16 to increase or decrease the activity time according to the actual situation. Therefore, the present invention solves the problem of requiring the robot 3 to calculate the estimated time by moving along the walls, resulting in the problem of wasting electric power.

In one embodiment of the present invention, the setting unit 16 can be disposed on the surface of the casing 18, and is a physical component such as a stepless rotary switch, a multi-position rotary switch or an electronic time setter, or the setting unit 16 is disposed in the casing 18, and is a wireless signal receiver, such as a Bluetooth or Wi-Fi wireless transmission module, that can receive the activity time sent by a remote electronic device, for example, an application (APP) of a smart phone is used to set the activity time, and is transmitted to the setting unit 16 via the Bluetooth or Wi-Fi wireless transmission module of the mobile phone. However, the present invention is not limited thereto in actual implementation, and any device that can be provided to set the activity time for the virtual wall device 1 belongs to the setting unit 16 being referred to in the present invention.

In order to cause the robot 3 to confirm whether entering or exiting the separated area 20, in the present invention, the virtual wall signal transmitting unit 12 of the virtual wall device 1 is provided with a first transmitting portion 120 and a second transmitting portion 122. The first transmitting portion 120 sends out an outer signal, a sending position of the outer signal is adjacent to the open area 22, and the second transmitting portion 122 sends out an inner signal, a sending position of the inner signal is adjacent to the separated area 20 of the workspace 2, and the outer signal and the inner signal form the virtual wall signal. An unique identification information and the activity time information set by each of the virtual wall devices 1 are respectively included in one of the outer signal and the inner signal, and are provided for the robot 3 to determine entering or exiting the separated area 20 divided by the virtual wall signal according to the order of receiving the outer signal and the inner signal, and to record the unique identification information.

In other words, when the robot 3 is driven by a driving unit to pass the virtual wall device 1, a virtual wall signal receiving unit receives the outer signal first, and then receives the inner signal, so that the robot 3 also receives the outer signal from the virtual wall signal receiving unit first, and then receives the inner signal, and the robot 3 confirms to have entered the separated area 20. On the contrary, the robot 3 receives the inner signal from the virtual wall signal receiving unit first and then receives the outer signal, the robot 3 confirms to have exited the separated area 20.

When the robot 3 receives the outer signal and obtains the unique identification information from the outer signal, the robot 3 determines whether the current unique identification information has been recorded, if the current unique identification information has not been recorded, the robot 3 records the current unique identification information, and the robot 3 is allowed to enter the separated area 20. Conversely, if the current unique identification information has been recorded, the robot 3 is prohibited from entering the separated area 20.

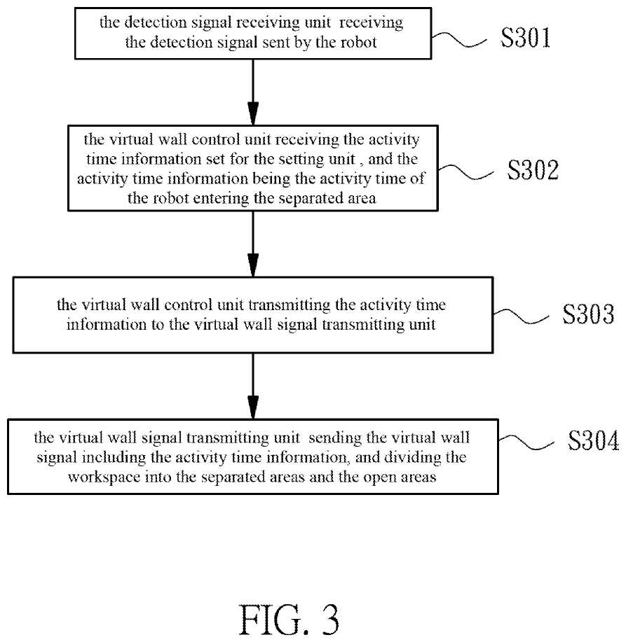

Referring to FIG. 3 for a control method of the virtual wall device of the present invention, wherein the virtual wall device 1 comprises the virtual wall control unit 10, the virtual wall signal transmitting unit 12, the detection signal receiving unit 14, and the setting unit 16, the steps performed by each of the components comprise:

(S301) the detection signal receiving unit 14 receiving the detection signal sent by the robot 3;

(S302) the virtual wall control unit 10 receiving the activity time information set for the setting unit 16, and the activity time information being the activity time of the robot 3 entering the separated area 20;

(S303) the virtual wall control unit 10 transmitting the activity time information to the virtual wall signal transmitting unit 12; and

(S304) the virtual wall signal transmitting unit 12 sending the virtual wall signal including the activity time information, and dividing the workspace 2 into the separated areas 20 and the open areas 22.

In order to save or reduce the power consumption of the virtual wall device 1, after the virtual wall control unit 10 transmits the activity time information to the virtual wall signal transmitting unit 12 of the virtual wall device 1, the virtual wall control unit 10 activates the virtual wall signal transmitting unit 12 only during the period in which the detection signal is received, and causes the virtual wall signal transmitting unit 12 to send the virtual wall signal, thereby achieving the object of saving or reducing the power consumption of the virtual wall device 1.

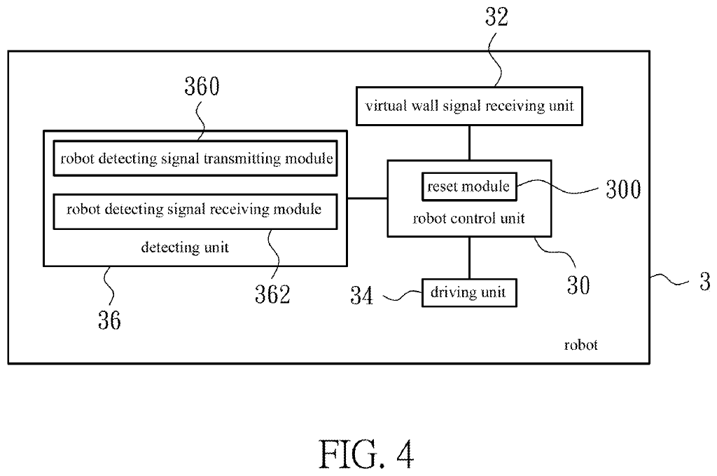

Referring to FIG. 4, the robot 3 is provided, comprising a robot control unit 30, a virtual wall signal receiving unit 32, a driving unit 34, and a detecting unit 36. Wherein the robot control unit 30 is connected to the virtual wall signal receiving unit 32, the driving unit 34, and the detecting unit 36. The driving unit 34 receives an operation command of the robot control unit 30 to drive the robot 3 to move. The operation command comprises various moving modes (for example, moving along walls, zigzag moving or vortex moving), escape mode, obstacle avoidance mode, enhanced cleaning mode, or returning to charging station mode, but are not limited thereto, all encoding programs written in the robot control unit 30 to cause the robot 3 to perform various actions according to the encoding programs, can be referred to as the operation command of the present invention. The virtual wall signal receiving unit 32 receives the virtual wall signal outputted by the virtual wall signal transmitting unit 12 of the virtual wall device 1. The robot control unit 30 uses a restriction command to cause the driving unit 34 to drive the robot 3 to move in the separated area 20 during the activity time, and prohibits to drive the robot 3 to leave the separated area 20. When the robot 3 is continuously active in the separated area 20 until reaching the activity time, the robot control unit 30 generates a leaving command to cause the driving unit 34 to drive the robot 3 to leave the separated area 20.

For example, the manner in which the robot control unit 30 causes the driving unit 34 to drive the robot 3 to leave the separated area 20 according to the leaving command is performed by the robot control unit 30 controlling the driving unit 34 to execute the mode of moving along walls, so that the robot 3 is brought near the virtual wall device 1 by the driving unit 34, and when the robot 3 receives the virtual wall signal, the robot control unit 30 allows the driving unit 34 to drive the robot 3 to cross the virtual wall signal and leave the separated area 20. However, in the present invention, the manner in which the robot control unit 30 causes the driving unit 34 to drive the robot 3 to leave the separated area 20 according to the leaving command includes but not limited to the robot control unit 30 causing the driving unit 34 to execute the mode of moving along walls, and any command that causes the robot 3 to leave the separated area 20 autonomously without the guidance of the virtual wall device 1 belongs to the leaving command of the present invention.

Further, in order to prevent the robot 3 from re-entering the separated area 20 after leaving the separated area 20, in the present invention, after the robot 3 leaves the separated area 20, the robot control unit 30 records a completion activity information. After the robot control unit 30 has recorded the completion activity information, when the robot control unit 30 receives the virtual wall signal again, since the robot control unit 30 confirms that the completion activity information has been recorded, the robot control unit 30 uses a prohibit command to cause the driving unit 34 to prohibit to drive the robot 3 to cross the virtual wall signal. The manner in which the robot control unit 30 records the completion activity information is performed by having the virtual wall signal further comprising the unique identification information set by each of the virtual wall devices 1. When the robot 3 passes the virtual wall signal, the robot control unit 30 receives the unique identification information, the robot 3 determines that the current unique identification information has not been recorded, the robot 3 records the current unique identification information, and continuing to cause the driving unit 34 to prohibit to drive the robot 3 to cross the virtual wall signal to enter the activity area. On the contrary, the robot 3 determines that the current unique identification information has been recorded, and the robot control unit 30 uses the prohibit command to cause the driving unit 34 to prohibit to drive the robot 3 to cross the virtual wall signal.

Furthermore, the manner in which the robot control unit 30 causes the driving unit 34 to drive the robot 3 to leave the separated area 20 according to the prohibit command is performed by the robot control unit 30 controlling the driving unit 34 to execute the obstacle avoidance mode, so that the robot 3 is driven by the driving unit 34 to leave the virtual wall device 1 (like the robot 3 avoiding obstacles), and is unable to enter the separated area 20. However, in the present invention, the manner in which the robot control unit 30 causes the driving unit 34 to prohibit the robot 3 from entering the separated area 20 according to the prohibit command includes but not limited to the robot control unit 30 causing the driving unit 34 to execute the obstacle avoidance mode, and any command that prohibits the robot 3 from entering the separated area 20 again belongs to the prohibit command of the present invention.

In the present invention, the detecting unit 36 of the robot 3 comprises a robot detecting signal transmitting module 360 and a robot detecting signal receiving module 362. Both the robot detecting signal transmitting module 360 and the robot detecting signal receiving module 362 are connected to the robot control unit 30. The robot detecting signal transmitting module 360 sends out a detection signal, and the robot detecting signal receiving module 362 receives the detection signal reflected by an obstacle (such as a wall or an indoor item) and transmits the detection signal to the robot control unit 30. The robot control unit 30 determines whether the obstacle is near according to the physical characteristics (such as: signal strength or phase change, but are not limited thereto) of the received detection signal, if determining to be approaching the obstacle, the preset obstacle avoidance mode is executed, and the robot control unit 30 causes the driving unit 34 to drive the robot 3 away from the obstacle with an obstacle avoidance command.

In addition, the robot control unit 30 is provided with a reset module 300, the reset module 300 defines a reset condition that the robot 3 is re-allowed to enter the separated area 20, and the reset condition includes power on, power off, and the like. The robot 3 can re-enter the separated area 20 if the reset condition is met, for example, the robot 3 is active in the separated area 20 for a period of time and has not reached the activity time, at this time, work (for example, cleaning) in the separated area 20 may not be completed yet, but the robot 3 has reached a low battery state that requires to return for charging, and the robot 3 preferentially executes a charging command to return to a charging station 4, allowing the robot 3 to leave the separated area 20 and move to the charging station 4 for charging. When the robot 3 reaches the charging station 4, the robot control unit 30 determines that the reset condition is met, so that after the robot 3 completes charging and passes near the virtual wall device 1 again, the robot 3 can cross the virtual wall signal and enter the separated area 20.

Furthermore, after the charging is completed, in order to avoid recurrence of work (for example, cleaning) in the separated area 20 may not be completed yet, but the robot 3 has reached the low battery state that requires to return for charging, the robot control unit 30 causes the driving unit 34 to drive the robot 3 to preferentially move to the separated area 20 of the last virtual wall device 1 according to a return command for returning to the separated area 20. The manner in which the robot 3 returns to the separated area 20 is performed by the robot control unit 30 executing the mode of moving along walls to cause the driving unit 34 to drive the robot 3 to move to the last virtual wall device 1 and allow to pass the virtual wall signal and enter the separated area 20.

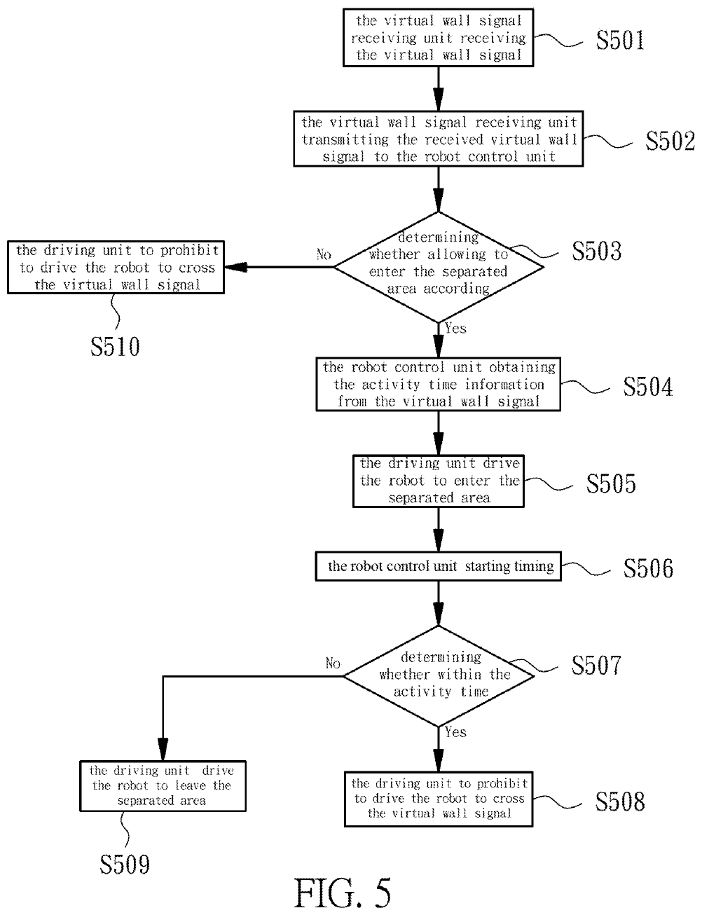

Referring to FIG. 5 for a control method for restricting movement of the robot 3 of the present invention, wherein the robot 3 at least comprises the robot control unit 30, the virtual wall signal receiving unit 32 and the driving unit 34, and performs the following steps:

(S501) the virtual wall signal receiving unit 32 of the robot 3 receiving the virtual wall signal outputted by the virtual wall signal transmitting unit 12 of the virtual wall device 1, wherein the virtual wall signal comprises the activity time information of the separated area the robot entering and divided by the virtual wall signal;

(S502) the virtual wall signal receiving unit 32 transmitting the received virtual wall signal to the robot control unit 30;

(S503) the robot control unit 30 determining whether allowing to enter the separated area 20 according to the virtual wall signal, if yes, performing step (S504), otherwise performing step (S508), wherein the manner in which the robot control unit 30 determines whether allowing to enter the separated area 20 according to the virtual wall signal can be performed by the robot control unit 30 determining whether the virtual wall signal is received for the first time or has entered the separated area 20 according to the virtual wall signal, further, when the robot 3 passes the virtual wall signal, the robot control unit 30 receives the unique identification information from the virtual wall signal, and the robot 3 determines that the current unique identification information has not been recorded, and the robot 3 records the current unique identification information;

(S504) the robot control unit 30 obtaining the activity time information from the virtual wall signal, in the present invention, for this step (S504) and the aforementioned step (S503), the order of performing being not limited, and being separated into the two steps being only for the sake of clearly describing what the robot 3 is performing;

(S505) the robot control unit 30 using the restriction command to cause the driving unit 34 to drive the robot 3 to enter the separated area 20 divided by the virtual wall signal;

(S506) the robot control unit 30 starting timing;

(S507) the robot control unit 30 determining whether within the activity time, if yes, performing step (S508), otherwise performing step (S509);

(S508) the robot control unit 30 using the restriction command to cause the driving unit 34 to prohibit to drive the robot 3 to cross the virtual wall signal, and performing the step (S507) again;

(S509) when an interval of timing of the robot control unit 30 in the separated area 20 reaching the activity time set in the activity time information, the robot control unit 30 using the leaving command to cause the driving unit 34 to drive the robot 3 to leave the separated area 20; and

(S510) when the robot control unit 30 determining not to allow to enter the separated area 20 according to the virtual wall signal, the robot control unit 30 using the prohibit command to cause the driving unit 34 to prohibit to drive the robot 3 to cross the virtual wall signal, in the present invention, the manner in which the robot control unit 30 determining not to allow to enter the separated area 20 according to the virtual wall signal being performed by the robot 3 determining that the current unique identification information having been recorded, and the robot control unit 30 using the prohibit command to cause the driving unit 34 to prohibit to drive the robot 3 to cross the virtual wall signal.

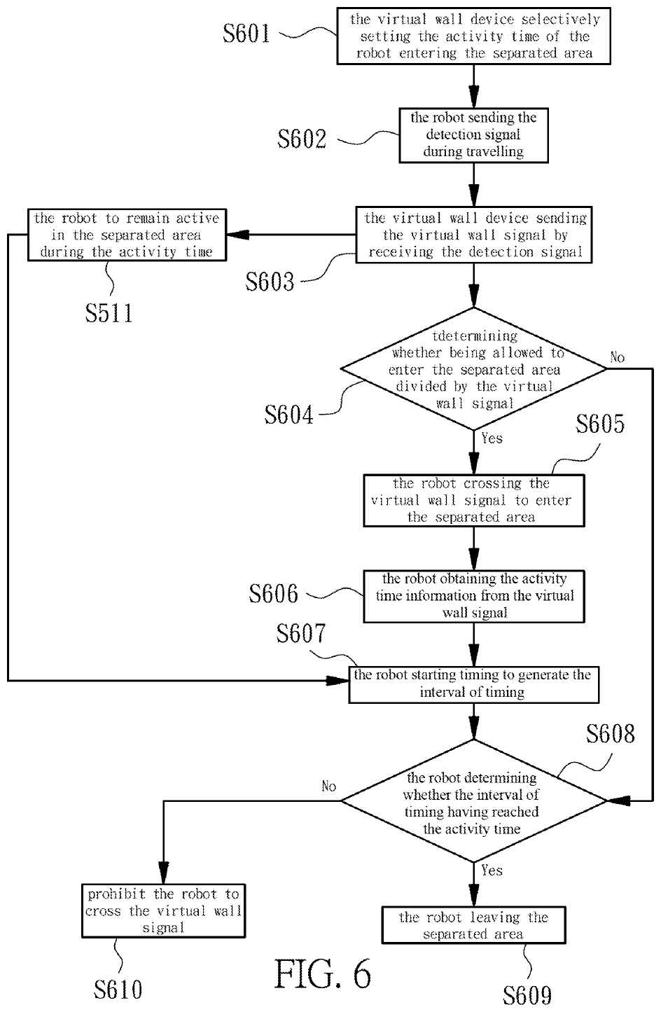

Referring to FIG. 6 for a control method for restricting movement of the robot 3 by the virtual wall device 1 of the present invention. The following steps are performed between the virtual wall device 1 and the robot 3:

(S601) the virtual wall device 1 selectively setting the activity time of the robot 3 entering the separated area 20;

(S602) the robot 3 sending the detection signal during travelling;

(S603) the virtual wall device 1 sending the virtual wall signal by receiving the detection signal, and the virtual wall signal comprising the activity time information generated according to the activity time;

(S604) the robot 3 receiving the virtual wall signal and determining whether being allowed to enter the separated area 20 divided by the virtual wall signal, if yes, performing step (S605), otherwise, performing step (S609), the manner in which the robot 3 determining whether being allowed to enter the separated area 20 divided by the virtual wall signal according to the virtual wall signal, at least can be as described in the step (S503);

(S605) the robot 3 crossing the virtual wall signal to enter the separated area 20;

(S606) the robot 3 obtaining the activity time information from the virtual wall signal;

(S607) the robot 3 starting timing to generate the interval of timing;

(S608) the robot 3 determining whether the interval of timing having reached the activity time, if yes, performing step (S609), otherwise, performing step (S610);

(S609) the robot 3 executing the leaving command and being allowed to cross the virtual wall signal and leaving the separated area 20;

(S610) after the robot 3 leaving the separated area 20 by executing the leaving command, using the prohibit command to cause the driving unit 34 to prohibit to drive the robot 3 to cross the virtual wall signal, the manner in which the robot control unit 30 determining not to allow to enter the separated area 20 according to the virtual wall signal being performed by the robot 3 determining that the current unique identification information having been recorded, and the robot control unit 30 using the prohibit command to cause the driving unit 34 to prohibit to drive the robot 3 to cross the virtual wall signal; and

(S611) the robot 3 using the restriction command to cause the driving unit 34 to prohibit to drive the robot 3 to cross the virtual wall signal, and causing the robot 3 to remain active in the separated area 20 during the activity time, and performing the step (S607) again.

In the present invention, after the robot 3 records the current unique identification information, the unique identification information is finally cleared from the robot 3 after the robot 3 restarts, automatically returns to the charging station 4 for charging or forcibly resetting the robot 3, in this way, the robot 3 will not repeatedly enter the separated area 20, and can enter the separated area 20 again under appropriate conditions. For example, the power of the robot 3 itself is sufficient for at least one time of cleaning work in the entire space, after the robot 3 automatically performs cleaning daily, the robot 3 can automatically return to the charging station 4 for charging, at this time, the unique identification information recorded by the robot 3 is cleared, so that the robot 3 can enter the separated area 20 every day for automatic cleaning.

According to the above description, in order to further understand the technical features of the present invention, please refer to FIG. 1, wherein the setting unit 16 of the virtual wall device 1 is a stepless rotary switch, the robot 3 is the cleaning robot 3, and the cleaning robot 3 is placed in a house to perform cleaning work. There are three rooms and a living room in the house, there is a door respectively between the living room and the rooms for communicating with each other, and the virtual wall device 1 is respectively placed under the doors of two of the rooms. In this way, the rooms with the virtual wall device 1 at the door is divided into the two separated areas 20 by the virtual wall device 1, and the living room and the other room without the virtual wall device 1 are the open areas 22. In addition, sizes of the two rooms are different, and therefore, the user sets the activity time to 10 minutes by operating the knob of the virtual wall device 1 in the larger room, and sets the activity time to 5 minutes by operating the knob of the virtual wall device 1 in the smaller room. In order to distinguish the two different virtual wall devices 1, assuming that the unique identification code of the virtual wall device 1 of the larger room is “A”, and is referred to as the A virtual wall device 1 below for short, the virtual wall signal sent by the A virtual wall device 1 is the A virtual wall signal, and the larger room is called the A separated area 20; and assuming that the unique identification code of the virtual wall device 1 of the smaller room is “B”, and is referred to as the B virtual wall device 1 below for short, the virtual wall signal sent by the B virtual wall device 1 is the B virtual wall signal, and the smaller room is called the B separated area 20.

To continue from the above, when the robot 3 is activated and the driving unit 34 drives the robot 3 in any moving mode (for example, random moving mode or zigzag moving mode), assuming that the robot 3 approaches the A virtual wall device 1 and receives the A virtual wall signal, because the robot 3 has never received the A virtual wall signal and is allowed to enter the A separated area 20, and the robot 3 is not allowed to pass the A virtual wall signal before the activity time in the A separated area 20 reaches 10 minutes, and once the activity time reaches 10 minutes, the robot 3 is allowed to pass the A virtual wall signal. In order to leave the A separated area 20, the robot 3 crosses the A virtual wall signal in the mode of moving along walls to enter the open area 22, and then moves in any mode in the open area 22. During this period, if the A virtual wall signal is encountered again, because the unique identification code “A” is recorded, the robot 3 leaves the A virtual wall signal in the obstacle avoidance mode; if the B virtual wall signal is encountered, because the robot 3 has never received the B virtual wall signal and is allowed to enter the B separated area 20, and the robot 3 is not allowed to pass the B virtual wall signal before the activity time in the B separated area 20 reaches 5 minutes, and once the activity time reaches 5 minutes, the robot 3 is allowed to pass the B virtual wall signal. In order to leave the B separated area 20, the robot 3 crosses the B virtual wall signal in the mode of moving along walls to enter the open area 22. Afterwards, the robot 3 will only be active in the open area 22 and will not enter any of the separated areas 20 again.

According to the above, the robot 3 of the present invention does not need to waste electric power to calculate the working time required for each of the areas, the robot 3 does not require the guidance of the virtual wall device 1 to leave the separated area 20, and the robot 3 and the virtual wall device 1 do not need to transmit or receive too many signals, and therefore, can greatly save the electric power of the robot 3 and the virtual wall device 1.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A virtual wall device, comprising:
a casing;
a virtual wall control unit disposed in the casing;
a setting unit disposed in the casing and connected to the virtual wall control unit, the setting unit setting an activity time of a robot entering a separated area in a workspace, and generating an activity time information according to the set activity time;
a detection signal receiving unit disposed in the casing and connected to the virtual wall control unit, receiving a detection signal sent by the robot, and transmitting the detection signal to the virtual wall control unit; and
a virtual wall signal transmitting unit connected to the virtual wall control unit, the virtual wall control unit activating the virtual wall signal transmitting unit to send the virtual wall signal during the period in which the detection signal being received, and the virtual wall signal dividing the workspace into the separated area and an open area; and
wherein the virtual wall control unit receives the activity time information, so that the virtual wall control unit commands the virtual wall signal transmitting unit to send the virtual wall signal including the activity time information.

2. The virtual wall device as claimed in claim 1, wherein the setting unit is disposed on a surface of the casing, and the setting unit is a physical component of a stepless rotary switch, a multi-position rotary switch or an electronic time setter.

3. The virtual wall device as claimed in claim 1, wherein the setting unit is disposed in the casing, and the setting unit is a wireless signal receiver.

4. The virtual wall device as claimed in claim 1, wherein the virtual wall signal transmitting unit comprises:
a first transmitting portion, the first transmitting portion sends out an outer signal, and a sending position of the outer signal is adjacent to the open area; and
a second transmitting portion, the second transmitting portion sends out an inner signal, and a sending position of the inner signal is adjacent to the separated area of the workspace; and
wherein the outer signal and the inner signal form the virtual wall signal, and provide for the robot to determine entering or exiting the separated area divided by the virtual wall signal according to the order of receiving the outer signal and the inner signal.

5. The virtual wall device as claimed in claim 4, wherein the virtual wall device is set with an unique identification information, and the activity time information and the unique identification information are respectively set in one of the outer signal and the inner signal.

6. A control method of a virtual wall device, the virtual wall device as claimed in claim 1 performing the following steps, comprising:
the detection signal receiving unit receiving the detection signal sent by the robot;
the virtual wall control unit receiving the activity time information set for the setting unit;
the virtual wall control unit transmitting the activity time information to the virtual wall signal transmitting unit; and
the virtual wall signal transmitting unit sending the virtual wall signal including the activity time information, and the virtual wall signal dividing a workspace into a separated area and an open area.

7. The control method of the virtual wall device as claimed in claim 6, wherein the virtual wall signal transmitting unit stops transmitting the virtual wall signal when the detection signal receiving unit has not received the detection signal.

8. A robot, comprising:
a robot control unit;
a virtual wall signal receiving unit connected to the robot control unit, and receiving a virtual wall signal outputted by a virtual wall signal transmitting unit provided by an external virtual wall device;
a driving unit connected to the robot control unit, and receiving an operation command of the robot control unit to drive the robot to move; and
a detecting unit, comprising:
a robotic detecting signal transmitting module connected to the robot control unit, and the robot detecting signal transmitting module sending out a detection signal; and
a robot detecting signal receiving module connected to the robot control unit, the robot detecting signal receiving module receiving the detection signal reflected by an obstacle and transmitting the detection signal to the robot control unit, the robot control unit receiving the detection signal indicating that the obstacle being near, and performing a preset obstacle avoidance mode to avoid the obstacle when approaching the obstacle;
wherein the robot control unit determines whether to enter a separated area divided by the virtual wall device according to the virtual wall signal; and
furthermore, the robot control unit obtains an activity time information from the virtual wall signal in a state of entering the separated area, and causes the robot control unit to use a restriction command to make the driving unit to drive the robot to move in the separated area within an activity time set in the activity time information, and to prohibit from leaving the separated area, and the robot control unit generates a leaving command when the activity time is reached to cause the driving unit to drive the robot to leave the separated area.

9. The robot as claimed in claim 8, wherein the robot control unit is provided with a reset module, the reset module defines a reset condition that the robot is re-allowed to enter the separated area, and the reset condition includes power on or power off

10. The robot as claimed in claim 8, wherein the robot control unit causes the driving unit to drive the robot to preferentially move to the separated area of the last virtual wall device according to a return command for returning to the separated area.

11. The robot as claimed in claim 10, wherein the return command of the robot control unit is performed by executing a mode of moving along walls to cause the driving unit to drive the robot to move to the last virtual wall device and allow to pass the virtual wall signal and return to the separated area.

12. A control method for restricting movement of a robot, wherein the robot at least comprises a robot control unit, a virtual wall signal receiving unit and a driving unit, and performs the following steps:
the virtual wall signal receiving unit receiving a virtual wall signal outputted by a virtual wall signal transmitting unit of a virtual wall device, wherein the virtual wall signal comprises an activity time information, and the activity time information is an activity time in a separated area the robot enters and divided by the virtual wall signal;
the virtual wall signal receiving unit transmitting the received virtual wall signal to the robot control unit;
the robot control unit determining whether allowing to enter the separated area according to the virtual wall signal;
when the robot control unit determining to allow to enter the separated area according to the virtual wall signal, the robot control unit obtaining the activity time information from the virtual wall signal;
the robot control unit using a restriction command to cause the driving unit to drive the robot to enter the separated area;
the robot control unit starting timing, the robot control unit using the restriction command to cause the driving unit to prohibit to drive the robot to cross the virtual wall signal within the activity time;
when an interval of timing of the robot control unit in the separated area reaching the activity time, the robot control unit using a leaving command to cause the driving unit to drive the robot to leave the separated area; and
when the robot control unit determining not to allow to enter the separated area according to the virtual wall signal, the robot control unit using a prohibit command to cause the driving unit to prohibit to drive the robot to cross the virtual wall signal.

13. The control method for restricting movement of the robot as claimed in claim 12, wherein the manner in which the robot control unit determines whether allowing to enter the separated area according to the virtual wall signal is performed by the robot control unit determining whether the virtual wall signal is received for the first time or has entered the separated area according to the virtual wall signal, when the robot passes the virtual wall signal, the robot control unit receives an unique identification information from the virtual wall signal, and the robot determines that the current unique identification information has not been recorded.

14. The control method for restricting movement of the robot as claimed in claim 13, wherein the manner in which the robot control unit determines not to allow to enter the separated area according to the virtual wall signal is performed by the robot determining that the current unique identification information has been recorded, and the robot control unit uses the prohibit command to cause the driving unit to prohibit to drive the robot to enter the separated area.

15. A control method for restricting movement of a robot by a virtual wall device, performing the following steps between the virtual wall device and the robot:
the virtual wall device selectively setting an activity time in a separated area the robot entering and divided by the virtual wall device;
the robot sending a detection signal during travelling;
the virtual wall device sending a virtual wall signal by receiving the detection signal, and the virtual wall signal comprising an activity time information generated according to the activity time;
the robot receiving the virtual wall signal, and determining whether being allowed to enter the separated area divided by the virtual wall signal;
when the robot being allowed to enter the separated area divided by the virtual wall signal, the robot obtaining the activity time information from the virtual wall signal;
the robot starting timing to generate an interval of timing;
the robot determining whether the interval of timing having reached the activity time;
when the robot determining the interval of timing having reached the activity time, the robot executing a leaving command and being allowed to cross the virtual wall signal and leaving the separated area; and
after the robot leaving the separated area by executing the leaving command, using a prohibit command to cause the driving unit to prohibit to drive the robot to cross the virtual wall signal.

16. The control method for restricting movement of the robot by the virtual wall device as claimed in claim 15, wherein when the robot determines the interval of timing has not reached the activity time, the robot uses a restriction command to cause the driving unit to prohibit to drive the robot to cross the virtual wall signal, and causes the robot to remain active in the separated area during the activity time, and performs the step of the robot starting timing to generate the interval of timing again.

17. The control method for restricting movement of the robot by the virtual wall device as claimed in claim 15, wherein the manner in which the robot determines whether being allowed to enter the separated area divided by the virtual wall signal according to the virtual wall signal is performed by the robot determining whether the virtual wall signal is received for the first time or has entered the separated area according to the virtual wall signal.

18. The control method for restricting movement of the robot by the virtual wall device as claimed in claim 17, wherein when the robot passes the virtual wall signal, the robot receives an unique identification information set by the virtual wall device from the virtual wall signal, and the robot determines that the current unique identification information has not been recorded, and the robot records the current unique identification information.

19. The control method for restricting movement of the robot by the virtual wall device as claimed in claim 18, wherein the manner in which the robot determines not being allowed to enter the separated area according to the virtual wall signal is performed by the robot determining that the unique identification information has been recorded, and the robot does not enter the separated area.
